(19) United States
(12) Patent Application Publication
(10) Pub. No.: US 2025/0023943 A1
(43) Pub. Date: Jan. 16, 2025

(54) AN ARCHITECTURE FOR SELF-ADAPTIVE COMPUTATION MANAGEMENT IN EDGE CLOUD

(71) Applicant: Telefonaktiebolaget LM Ericsson (publ), Stockholm (SE)

(72) Inventors: Mbarka SOUALHIA, Quebec (CA); Carla MOURADIAN, Quebec (CA)

(21) Appl. No.: 18/711,358

(22) PCT Filed: Nov. 19, 2021
(86) PCT No.: PCT/IB2021/000822

§ 371 Date: May 17, 2024

(51) Int. Cl. H04L 67/1008; H04L 67/1029

(52) U.S. Cl. CPC H04L 67/1008; H04L 67/1029

(57) ABSTRACT

Methods and systems are described for computation management of requests in edge cloud domains. A user equipment can send a computation management request. The network can determine the criteria for completing the computation management request, determine static and dynamic status of network resources, assess historical data on performance success and failure and use all of these factors to assign a network resource to respond to the computation management request.

### TECHNICAL FIELD

The present disclosure is directed to edge cloud domain resource management.

### BACKGROUND

With the emergence of variety of IoT (internet of things) devices, mobile computing becomes an important paradigm to enable computing and communication anywhere and anytime. The applications accessed by these devices, not only consume considerable amount of energy and resources, but they have computing and time requirements to meet the expectations of the end-users. In practice computation management in edge environments is affected by many factors which makes computation decisions unable to meet the expected requirements. In edge environments, the computation management decisions are affected by many factors such as task characteristics, network conditions, and platform differences. For example, an unstable network condition may negatively impact the benefits of computation offloading from devices to edge.

### SUMMARY

One embodiment under the present disclosure comprises a method performed by a computation management system in an edge domain for performing edge cloud computation management. The steps can include: receiving a computation management request from a UE (user equipment); obtaining one or more request criteria associated with the computation management request; and obtaining one or more user specifications from previously stored user specifications. The method can further include obtaining one or more application specifications from previously stored application specifications and selecting one of the one or more request criteria based on the one or more request criteria, the one or more user specifications, and the one or more application specifications. It can further comprise obtaining static status and dynamic status for one or more network resources; and obtaining one or more management strategies and related success rates from a database. The method can also include generating an adaptive management strategy based on the one or more request criteria, the one or more user specifications, the one or more application specifications, the static status, the dynamic status, and the one or more management strategies; performing the generated adaptive management strategy to complete the computation management request; and storing the generated adaptive management strategy in the database.

A further embodiment can comprise a method performed by a network node for performing edge cloud computation management. The method includes receiving a computation management request from a UE, and further includes determining dynamically a status of one or more network resources according to one or more criteria, and comparing the computation management request to one or more historical data. Further steps include determining which of the one or more network resources to use to perform the computation management request based on the one or more criteria and the one or more historical data and sending a command to the selected network resource to perform the computation management request.

Another embodiment comprises an edge cloud resource management system. The system can comprise a computation analyzer, a discovery engine, a computation manager and a computation agent. The computation analyzer is configured to; receive computation management requests from a UE (user equipment); obtain one or more request criteria associated with the computation management request from a request profiles database; obtain one or more specifications related to a user or an application from a specification repository; select one or more of the request criteria based on the one or more request criteria and the one or more specifications. The discovery engine is configured to store one or more factors related to one or more resources. The computation manager is configured to; receive the computation management request, the one or more request criteria and the one or more specifications from the computation analyzer; receive the one or more factors from the discovery engine; obtain one or more management strategies and related success rates from a management strategies database; generate an adaptive management strategy comprising one or more tasks and based on the one or more request criteria, the one or more specifications, the one or more factors, and the one or more management strategies and their related success rates; and save the generated adaptive management strategy in the management strategies database. The computation agent is configured to; receive the generated adaptive management strategy from the computation manager and to manage the performance of the one or more tasks; and send to the discovery engine a request to update the one or more factors.

This summary is provided to introduce a selection of concepts in a simplified form that are further described below in the detailed description. This summary is not intended to identify key features or essential features of the claimed subject matter, nor is it intended to be used as an indication of the scope of the claimed subject matter.

### BRIEF DESCRIPTION OF THE DRAWINGS

For a more complete understanding of the present disclosure, reference is now made to the following descriptions taken in conjunction with the accompanying drawings, in which:

FIG. 1 is a diagram of a computation management strategy system under the present disclosure;

FIG. 2 is a process flow diagram of an embodiment under the present disclosure;

FIG. 3 is a process flow diagram of an embodiment under the present disclosure;

FIG. 4 is a diagram of a computation manager embodiment under the present disclosure;

FIG. 5 is a diagram of a state diagram used by some embodiments under the present disclosure;

FIG. 6 is a diagram of a user equipment embodiment under the present disclosure;

FIG. 7 is a diagram of a node embodiment under the present disclosure;

FIG. 8 is a flow chart of a method embodiment under the present disclosure;

FIG. 9 is a flow chart of a method embodiment under the present disclosure; and

FIG. 10 is a flow chart of a method embodiment under the present disclosure.

### DETAILED DESCRIPTION

Before describing various embodiments of the present disclosure in detail, it is to be understood that this disclosure is not limited to the parameters of the particularly exemplified systems, methods, apparatus, products, processes, and/or kits, which may, of course, vary. Thus, while certain embodiments of the present disclosure will be described in detail, with reference to specific configurations, parameters, components, elements, etc., the descriptions are illustrative and are not to be construed as limiting the scope of the claimed embodiments. In addition, the terminology used herein is for the purpose of describing the embodiments and is not necessarily intended to limit the scope of the claimed embodiments.

In edge environments, the computation management decisions are affected by many factors such as task characteristics, network conditions, and platform differences. For example, an unstable network condition may negatively impact the benefits of computation offloading from devices to edge. Furthermore, applications may experience poor performance when computation management decisions do not consider variations of network and computing factors. Therefore, making computation management decisions according to different factors and their unpredictable variations in edge cloud is a challenging problem to achieve the required performance for applications (e.g., IoT applications) and ensure a better quality of service delivered to users.

Considering the foregoing, it is of interest to design an automated system/architecture to dynamically select the computation management strategies and to adapt them, on the fly, to the status of the edge and cloud system.

Existing solutions have numerous shortcomings. Most of existing solutions consider static objective function and predefined strategies for computation management. Most of existing solutions do not consider the large scale, the complexity, and the dynamic nature of the cloud, the edge, and devices where the resources, the network conditions, the locations, the utilization rate, the running load, and the availability change constantly. Existing solutions also require input from the users. They have fixed criteria or objective functions that do not change over time. This aspect can be critical considering the dynamic nature of the applications and cloud/edge domains. In addition, the criteria/objective to take the computation management decisions and types are usually static which may lead to poor computation management decisions. Furthermore, existing works do not propose a full-stack and cooperative end-to-end solution/architecture that considers constraints and sharing important data from different system players (devices/edges/cloud/application/etc.).

Embodiments under the present disclosure include systems, architectures, devices, and methods that can automatically reason and dynamically select the computation management strategies and to adapt them, on the fly, to the status of the cloud and edge systems. Edge computing is a type of cloud computing, with computation and other resources located in a cloud, not on a UE or IoT device. However, edge computing tends to focus on brining resources as close to UE or IoT devices as possible. In this way latency and bandwidth can be reduced and user experience improved. Certain embodiments under the present disclosure can comprise a self-adaptive architecture for computation management in edge cloud domains. Certain embodiments can automatically and dynamically select the appropriate computation management strategies and adapt them on the fly considering the dynamic nature of cloud and edge systems.

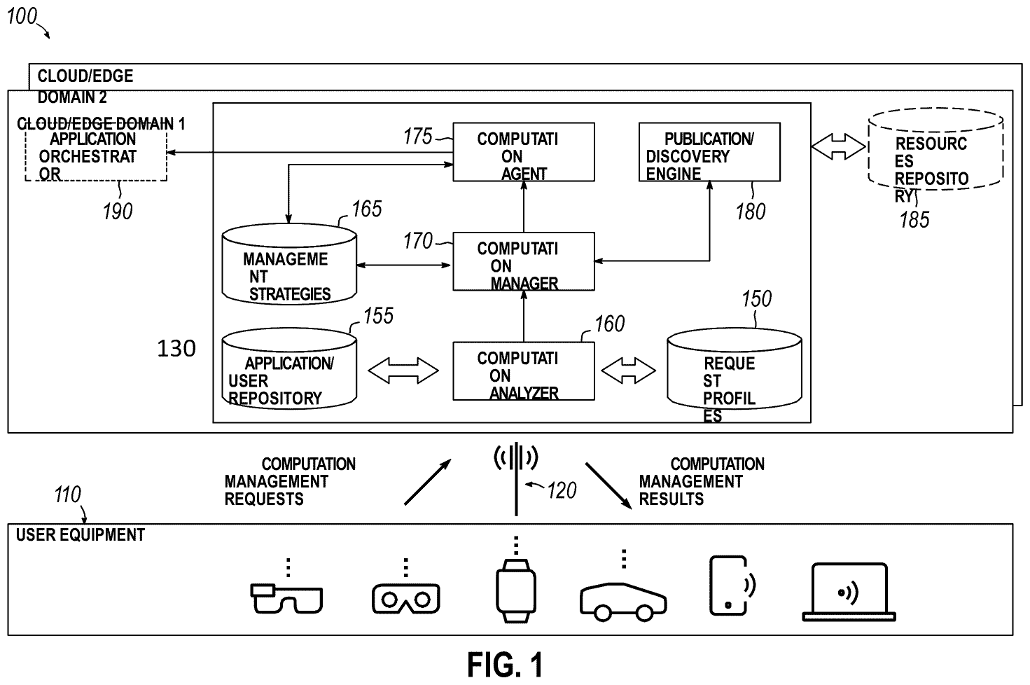

FIG. 1 displays a possible system embodiment 100 under the present disclosure. FIG. 1 presents an overview of the different components in one possible architecture that allows for dynamically selecting the computations management strategies and adapting them, on the fly, to the status of the edge cloud domain. This architecture embodiment, and others under the present disclosure, could be deployed and distributed across cloud and edge domains to ensure cooperative and coordinated management decisions. System 100 shows a cloud/edge domain 1 that is providing telecommunication connectivity or services to a user equipment (UE) 110. The UE 110 can be any connected device, such as virtual reality glasses, gaming devices, smart watch, mobile device, car, computer, or others. Computation management system 130, application orchestrator 190, and resources repository 185 can comprise cloud/edge domain 1. Computation management system 130 can comprise several components to assist in developing computation management strategies. Computation manager 170 can communicate with computation agent 175, publication or discovery engine 180, computation analyzer 160, and management strategies database 165. In this embodiment, computation manager 170, computation agent 175, publication or discovery engine 180, computation analyzer 160, specifications repository 155, request profiles 150, and management strategies database 165 comprise the computation management system 130. However, computation management system 130 can comprise additional or fewer modules, databases, repositories, and components depending on the specific embodiment.

In certain embodiments under the present disclosure, the computation analyzer 160 can be the component that communicates directly with the UE 110. When the UE 110 has a need for assistance from the cloud/edge domain 1, it can send a computation management request to the computation analyzer 160. Users can access the services offered by applications deployed in edge-cloud environments through UE 110. The computation management requests can be submitted by the UEs 110 when these equipment do not have the required resources to perform the selected services. A computation management request could contain some or all the following information, or more information: application, service, user, time, location, battery level, program code, application specification, user requirement, etc.

Then, the computation analyzer 160 can obtain one or more request criteria associated with the computation management request from request profiles database 150, and obtain one or more specifications related to a user and/or an application from specifications repository 155. Criteria can include latency, cost, total resource utilization, application names, location, processing power, user, application type, computation criteria/objective, location, success rate, and more. Specifications can include location, device name or type, latency, cost, total resource utilization, user, application type, computation criteria/objective, success rate, and more. Computation analyzer 160 may select one of the criteria (based on the one or more criteria and the one or more specifications) as a most important or key metric in developing computation management strategies. The computation analyzer 160 can communicate with computation manager 170 and send it the computation management request, the one or more request criteria and the one or more specifications. The computation manager 170 can then retrieve, from the discovery engine 180, one or more factors related to one or more network resources. The discovery engine can store static and dynamic measurements or status of various network resources. Network resources can include both local and remote resources and can include nodes, databases, cloud components, computing devices, servers, and other cloud or edge domain resources. The one or more factors can include processing power, wait time, latency, availability, utilization rate, maximum allowed capacity, node location, running load, and more. Remote resources may be located in, or comprise, a cloud/edge domain 2 that is in communication with, but remote or distinct from, cloud/edge domain 1. The computation manager 170 can also retrieve one or more management strategies and/or related success rates from a management strategies database 165. The management strategies database 165 can store various management strategies or protocols, historical records of previously used management strategies, and outcomes or success rates of various strategies. A specific management strategy may identify a specific resource or a set of resources to use for a specific type of request, depending on specific request type, location, requesting device, along with variables such as overall network traffic, traffic within a specific region, and other variables. The computation manager 170 can then generate an adaptive management strategy that may comprise one or more tasks for one or more network resources to perform in order to complete the computation management request. The computation manager 170 can compare the computation management request to previously used management strategies from the management strategies database 165. There may be a previously used strategy(ies) that maps onto the current request. If no previous strategy maps onto the current request, computation manager 170 can generate a new one based on a Markov Decision Process (MDP) or Q-learning (QL) algorithm (described below) by composing a set of actions that accomplish the computation management request. Actions or tasks can be defined by the computation manager 170 that link a series of states identified by MDP or QL algorithms (described further below). The set of actions, or tasks, can complete the computation management request so as to maximize some variable, such as efficiency, or can merely comprise steps that complete the request. The generated adaptive management strategy may be based on the one or more request criteria, the one or more specifications, the one or more factors, and the one or more management strategies and their related success rates. A generated adaptive management strategy can comprise one or more instructions indicating where to execute an application or task of an application, such as e.g., <execute task T1from application A1 on edge node 1, offload tasks T2 and T3 on edge node 3 and execute task T4locally, execute task T5 locally>. The generated adaptive management strategy can then be saved in the management strategies database 165 along with historical data to use in the future when new computation management requests are received. A computation agent 175 can communicate with the computation manager 170 and receive the generated adaptive management strategy and then manage the performance of the one or more tasks. This may involve sending commands to network resources to perform some or all of the tasks. The computation agent 175 or the computation manager 170 may send a request to the discovery engine 180 to update any factors that need updating. The discovery engine 180 may then update its own records or send updates to a resources repository 185. An application orchestrator 190 may be in communication with computation agent 175 and may assist in performing the one or more task or arranging for other network resources to perform the tasks. In case a strategy fails, the management strategies database 165 will be updated with the success rate of that strategy indicating a failure, so the system can avoid such decisions in the future, when applied to similar application/user/device specifications and current system conditions. The computation manager 175 may try to generate a strategy (based on identified criteria, specifications, or other factors) that upon review maps onto a previously failed strategy. The system can return a false/error message indicating that the analyzed strategy is not feasible or desirable.

Additional examples and description of the components shown in FIG. 1 can assist in understanding the benefits of various embodiments under the present disclosure.

The computation analyzer 160 is able to receive computation management requests from devices (e.g., IoT devices), analyze and profile the received requests, analyze the user and application specifications/requirements, profile the received requests to identify their corresponding criteria/objective function, and store historical data/statistics about users/applications/devices that are part of computation management requests to capture any change/new event. It can comprise an interface to ensure communication and coordinate computation operations between the cloud-edge domains and the user equipment. It can also perform profiling of the received requests to identify the criteria or the objective function to be considered for the received computations. Among its capabilities, the computation analyzer 160 can receive, process, and transmit information about the computation management requests. It may perform dynamic profiling of the received request to identify the criteria or the objective function they could consider (i.e., latency, cost, total resource utilization, etc.). These data can be saved into request profiles database 150 that contain statistics about the received requests including user, application type, computation criteria/objective, location, success rate, etc. It may additionally store and save historical data and statistics about the users, applications, devices that were part of the computation management requests into application/user repository 155. These data can be important to dynamically capture any change or new events that could happen at user/application/device side and may affect the management decision.

Discovery engine 180 (or publication engine) can handle requests to discover the static and dynamic factors of local and remote resources and get their descriptions and their capabilities. It can also publish or communicate new factors that characterize the existing resources and their description with new changes. Discovery engine 180 may send requests to resources repository 185 where the description and availability of each cloud and edge domains can optionally exist. It can also be used to publish into the resources repository 185 new factors that characterize the existing resources, including their description (i.e., availability, utilization rate, maximum allowed capacity, node location, running load, etc.) on the cloud/edge domains 1 and 2 to be discovered and used by the computation manager 170 or other applications. Discovery engine 180, by providing current status of resources, allows management strategies to be adapted to current and real-time variables. Static and dynamic variables can impact failure rates or analysis of historical failure rates. For example, a failure rate for a given management strategy may be expected to be one value for a given utilization and latency status, and different when utilization and latency are updated by the discovery engine 180 to their current values. Resources repository 185 is shown as separate from discovery engine 180. Resources repository 185 can comprise an existing module comprising a portion of a cloud/edge domain 1, that could be reused and/or adjusted in the embodiments described herein. Resources repository 185 could also comprise a portion of discovery engine 180 or other components. Multiple databases or repositories shown in the current disclosure could be co-located but logically distinct components of the system.

Computation manager 170 can generate adaptive strategies for computation management to improve the overall performance of cloud/edge domains 1 or 2. It can also help avoid poor decisions using reinforcement learning techniques. It can dynamically discover different factors and their unpredictable variations in cloud/edge domains and adjusts the decisions to events occurring on the monitored system; dynamically discover domains where to offload based on changing criteria and adjusts the decisions to events occurring on the monitored system; identify different factors characterizing the devices, applications, users, and cloud-edge environments; and build a knowledge-based repository about computation management strategies and different constraints/criteria/events/etc. The types of criteria or specifications used can include availability of resources, failure rate, energy consumption level, and others. Computation manager 170 can consider different factors characterizing the devices, applications, users, and cloud-edge environments, and hence allows for a dynamic computation management strategy over time. When triggered by the computation analyzer 160, it can analyze the received data that includes the criteria to be considered for the computation management request and retrieves the description of the available (local and remote) resources from the discovery engine 180. Next, it can use this information to identify the appropriate computation management decision (where and how to manage and coordinate) that will be submitted to the computation agent 175.

The computation agent 175 is the entity responsible for executing the decisions made by the computation manager 170. it coordinates the management of the computation strategies with other components from cloud/edge domain 1 or cloud/edge domain 2 (and/or other cloud/edge domains) when needed. It can also save the results of computation management processing to build a knowledge-based repository to be used in the future. This can be stored in the management strategies database 165. Storing management strategies can include storing Q-value table in Q-DB and updating the computation management strategies. Computation agent 175 can coordinate the execution of the computation management requests with an application orchestrator 190 when needed. When the computation manager 170 decides to process a computation locally, computation agent 175 can locally performs/executes the received computations. Otherwise, it can send a request to the cloud domain 2 (or cloud domain n) selected by the computation manager 170 to perform the received computation. Furthermore, it can optionally coordinate the execution of the computation management requests with the application orchestrator 190 when needed. Application orchestrator 190 can comprise an existing module that can be incorporated into the described architecture.

Benefits from embodiments under the present disclosure are numerous. For example, embodiments include a self-adaptive architecture that allows for dynamically and automatically selecting ideal or preferred computation management strategies and adapting them to the current status of the edge cloud system. It also allows for a full-stack and cooperative architecture allowing sharing of important data between all system players (devices/edges/cloud/application/etc.) to make better cloud operations decisions on the fly as events occur in the cloud environment. It allows for continuous learning and building of knowledge-based repository about computation management strategies and different constraints/criteria/events/etc. Also provided are mechanisms to extend/apply the dynamic and self-adaptive architecture for computation management operations, such as offloading, placement, service mapping, scaling, scheduling, etc.

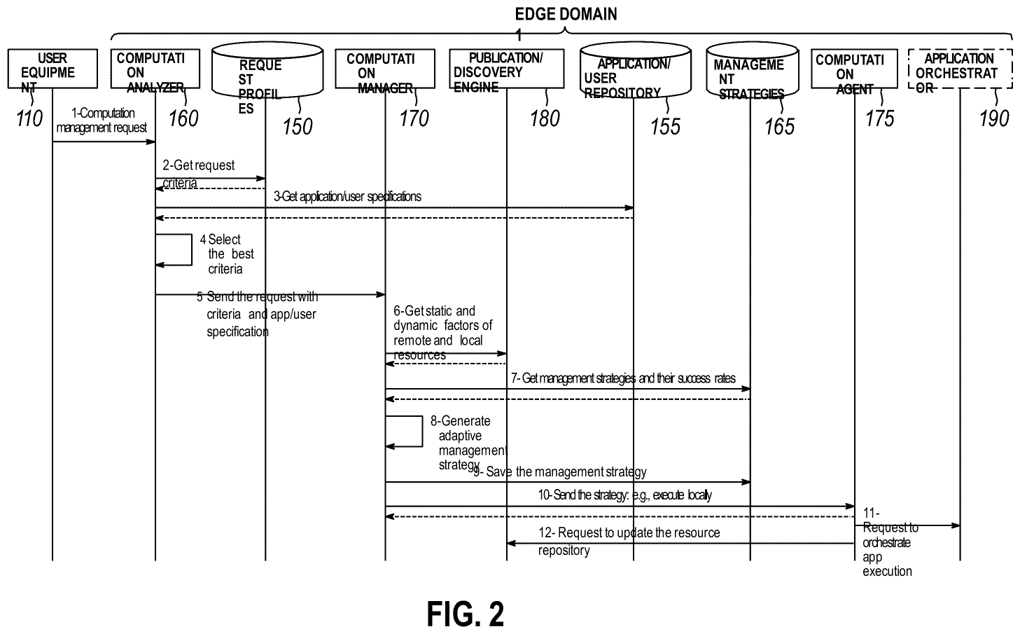

FIG. 2 can help in showing one embodiment of a process flow carried out by an edge domain in responding to a computation management request from a UE. Edge domain 1 comprises the closest edge domain to the UE. FIG. 2 depicts a sequence diagram that describes the steps followed in one embodiment of an architecture for the computation management process. The UE sends a computation management request to the computation analyzer on the edge domain in proximity of the UE. The request may indicate to manage the computation of a task T of an application or the entire application on this edge domain, i.e., edge domain 1. Along with this request, the UE can send the required program codes and parameters for the application, location, time, battery level, user requirements, etc. The UE can decide to send a computation management request because of its limited computing resources, its energy consumption, or some other factors.

The computation analyzer profiles the received request's criteria and fetches the request's information from request profiles (if found). The computation analyzer can get application/user specification from the application/user repository. The computation analyzer can analyze the request and identify appropriate criteria/objectives that can be considered when generating a computation management strategy. It does that using the information in the request profiles and the application/user repository. The computation analyzer sends the request with the identified criteria and application/user specifications to the computation manager.

The computation manager requests the static and dynamic status of local and remote resources from the publication/discovery engine. The latter gets the status of local resources from the resources repository of the local edge domain i.e., edge domain 1, while it gets the status of remote resources from the publication/discovery engine of other available domains. The computation manager can obtain existing computation management strategies from the management strategies repository. The computation manager then generates adaptive computation management strategies using reinforcement learning techniques (described below). It can do that using the identified request criteria, the application/user specifications, the static and dynamic factors of local and remote resources, and the existing or historical management strategies and failure rates. The computation manager saves its management strategy in the management strategies repository. This information can be used later in the future to generate a better or more adaptive computation management strategies. The information in the management strategies repository can also be published to other domains periodically to assist them when generating computation management strategies.

The computation manager sends the generated computation management strategy to the computation agent. In this example, it is assumed the computation manager decides to execute the task or tasks identified in the received computation locally, that is in edge domain 1. Hence, the computation agent in the edge domain 1 proceeds with the execution of this decision. Once the computation starts on edge domain 1, the computation agent requests the application orchestrator to orchestrate execution of the application (if needed). In this step, the computation agent instructs the publication/discovery engine to update the resources repository with the current capabilities of the edge nodes such as their available resources, running load, etc. It also updates the management strategies repository with the success results of the computation management request.

Results of the computation management request can be sent back to the UE through appropriate APIs (application programming interfaces) used by the computation analyzer or other components. In some embodiments, the results can be sent back to UEs through a data/forwarding plane. The architecture described above focuses more on the control/management plane. However, data plane interfaces can be designed using RESTful web services principles which expose CRUD (Create, Read, Update, and Delete) operations. Accordingly, the results can be forwarded from the cloud/edge domain to the UE domain through such interfaces.

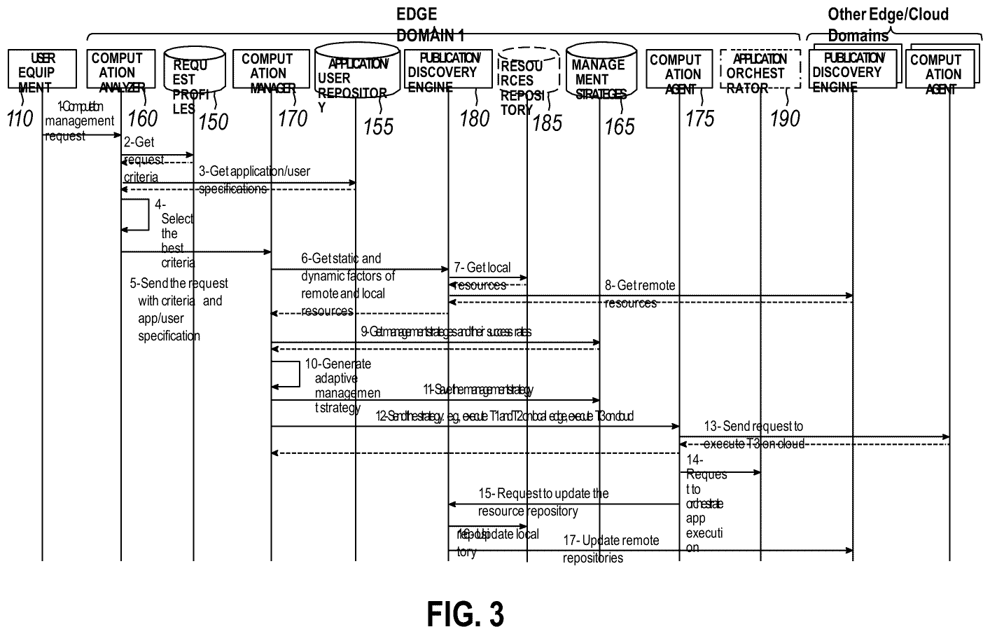

FIG. 3 depicts another embodiment of a process flow diagram that describes the steps followed in a proposed architecture for the computation management process. In this embodiment, the UE's computation is executed on its closest Edge Domain and some other remote edge/cloud domains. Please note that some of the steps described in FIG. 3 are similar to the steps in FIG. 2. However, more detail is given to provide a full description of the flow and the exchanged information.

The UE sends a computation management request to manage the computation of tasks T1, T2, T3 of an application to the computation analyzer in the edge domain in proximity of the UE, i.e., edge domain 1. Along with this request, the UE can send the required program codes and parameters for the application, location, time, battery level, user requirements, etc. The UE can decide to send computation management request because of its limited computing resources, its energy consumption, or other factors. It is assumed for illustrative purposes that, in FIGS. 3, T1 and T2 are latency sensitive while T3 is computationally intensive.

The computation analyzer profiles the received request's criteria and fetches the request's information from the request profiles repository (if found). The computation analyzer also gets application/user specification from the specification repository. The computation analyzer then identifies the most appropriate criteria/objectives to be considered when generating the computation management strategy. It does that using the information retrieved from the request profiles repository and the specification repository. The computation analyzer sends the request with the identified criteria and application/user specifications to the computation manager.

The computation manager requests the static and dynamic factors of local and remote resources from the publication/discovery engine. The static and dynamic factors of local resources are discovered by the publication/discovery engine from the resources repository in the same domain i.e., edge domain 1. The publication/discovery engine discovers the static and dynamic factors of remote resources by communicating with publication/discovery engine in the other domains e.g., cloud domain, other edge domains.

The computation manager gets computation management strategies from the management strategies repository. The computation manager then generates adaptive computation management strategies using reinforcement learning techniques. It does that using the identified criteria of the request, the application/user specifications, the static and dynamic factors of local and remote resources, and the existing management strategies. The computation manager may generate a strategy that maximizes the identified criteria. In some embodiments, the identified criteria may need to be adjusted or weighted differently by the computation manager depending on static and/or dynamic factors or the application/user specifications. The computation manager saves its management strategy in the management strategies repository. This information can be used in the future to generate further adaptive computation management strategies. The information in the management strategies repository is also published to other domains periodically to assist them in generating computation management strategies.

The computation manager sends the generated computation management strategy to the computation agent. In this example, it is assumed that the computation manager decides to execute the computation of tasks T1 and T2 locally, on edge domain 1, while executing the computation of task T3 on a remote cloud domain. Hence, the computation agent in the edge domain 1 executes the decision made. The computation agent in edge domain 1 sends task T3 to the corresponding computation agent in the remote cloud domain for execution. Once the computation starts on the decided domains, the computation agent requests the application orchestrator to orchestrate execution of the application.

Finally, the computation agent instructs the publication/discovery engine to update local and remote resources repository with the current capabilities of the edge nodes such as their available resources, running load, etc. Accordingly, the publication/discovery engine updates the local resources repository in edge domain 1 and sends request to other domains to update their resources repository. It also updates the management strategies repository with the success results of the computation management request.

More description can now be provided regarding how management strategies are developed and applied for responding to computation management requests under the present disclosure. As described above, in certain embodiments the computation analyzer is responsible for receiving a computation management request from the UEs, processing and analyzing the requests, and transmitting information about these requests. It is also responsible for profiling the received requests dynamically to identify the criteria or the objective functions to be considered by the computation manager when generating a computation management strategy. In addition, it stores and saves historical data and statistics about the users, applications, devices involved in the computation management requests. In order for the computation analyzer to identify the appropriate criteria or the objective functions to be considered by the computation manager, it uses the information of the profiled requests retrieved from the request profiles repository and the information of the applications/users/etc. retrieved from the specifications repository. A request can have n criteria/objective functions in the request profiles database, each with a success rate, such as a historical success rate. The “success rate” could be defined as the percentage of success among a number of attempts when selecting a specific criteria/criterion from the request profiles with respect to a specific request. Considering n criteria, then, there will be (2\hat{ }n)−1 possible sets to select from. The table below shows an example of the profiled requests, with their criteria and historical success rates. Assuming Request 1 has two criteria (i.e., latency and cost), then there are 3 possibilities for the computation analyzer to select from.

TABLE 1
Example of requests with their criteria and success rates

| Criteria | Latency | Cost | Latency & Cost |
|---|---|---|---|
| Request 1 | 0.2 | 0.4 | 0.2 |
| Request 2 | 0 | 0.9 | 0.4 |
| Request m | 0.6 | 0.3 | 0.8 |

One goal of the computation analyzer is to select the best criterion or the best combination of criteria so that the computation manager can utilize it to generate appropriate computation management strategy. In addition, when a request arrives to the computation analyzer, this request may include the important criteria of this request to be considered at the time. This importance is defined as probability. For instance, Request 1 may define that the latency is more important (with probability 0.4) compared to the cost (with probability 0.3) at a given point in time. The computation analyzer can also utilize the information in the specification repository. For instance, the application to which Request 1 belongs might be latency-sensitive, hence a probability with the value 1 for the latency is defined for this Request 1.

For each column in Table 1 above, the computation analyzer calculates a value V for probability rate. The value V can be calculated using different methods. One possible method under the present disclosure is as follows.

$$V ( criteria ) = \frac{{\sum }_{1}^{k} {probability}_{k}}{k}$$

where k is the number of items being considered (i.e., when there are two variables included, k=2, when there are three variables included, k=3, and so forth). probabilityₖ can indicate the historical success rate, the defined importance in the request, and/or the application specification.

Considering the above example, the values V for the columns in the table in Table 1 are calculated as follows. These examples are given in regards to Request 1.

$$V ( latency ) = \frac{0.2 + 0.4 + 1}{3} = 0.53$$

The value 0.2 is given by the table for historical success rate for latency, 0.4 is given by the relative important of latency over cost, and 1 is an application defined value for this request. Accordingly, V(cost) and V(latency & cost) can be given as follows:

$$V ( cost ) = \frac{0.4 + 0.3 + 0}{3} = 0.23$$

$$V ( latency \& cost ) = \frac{0.2 + \frac{0.4 + 0.3}{2} + 0}{3} = 0.18$$

The objective of the CA is to maximize V, meaning selecting the set with the highest V value. If the search space is big, then different multi-objective optimization algorithms can be used. For instance, Particle Swarm Optimization (PSO) heuristic algorithm can be applied to the problem to select the set with the highest V value. In the case where none of the probabilities exist, the CA cannot calculate the V value. Hence, it can perform a random criteria selection.

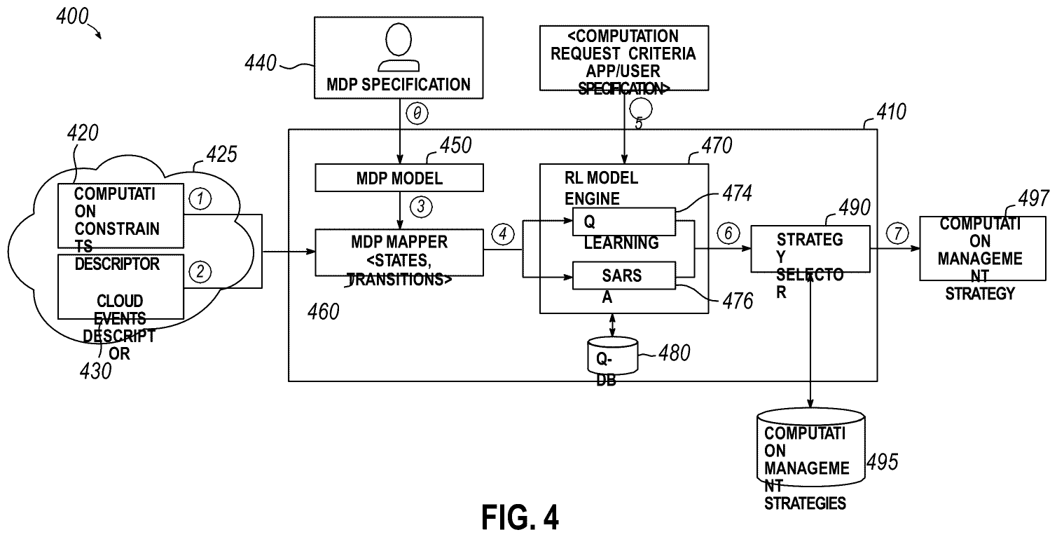

Further description of the computation manager can be useful in understanding how management strategies are developed in embodiments under the present disclosure. FIG. 4 shows components of one embodiment of the computation manager component of our proposed architecture. The computation manager generates adaptive computation management strategies using reinforcement learning (RL) techniques based on data collected from the cloud-edge environment.

One way to model the decision at the computation manager is as a Markov Decision Process (MDP). The MDP presents a solution to systematically solve multiple stage probabilistic decision-making problems where the behavior of the system depends on random factors. To learn an MDP and find its optimal strategy, RL can be used to achieve this goal. RL is a type of machine learning to learn how the environment is dynamically behaving by performing actions to maximize a cumulative reward function. Different RL algorithms exist in the literature, such as Q-Learning, and SARSA (State-Action-Reward-State-Action).

Description is given below regarding two RL algorithms, but it is to be understood that other RL algorithms and embodiments are possible. The specific examples given are for illustrative purposes and are not intended to limit the present disclosure. The two RL algorithms illustrated can be used to select the appropriate strategy to manage the received computation management request. Both Q-learning and SRASA algorithms learn Q values (in a format of Q-table) that is represented as ‘Qπ(s, a)’ that refers the return value of the current state ‘s’, applying action ‘a’ under strategy ‘π’. Q-Learning is an off-policy RL algorithm that selects the strategy with maximum reward value while SARSA is an on-policy RL algorithm that selects the next state and action according to a random strategy.

The following description of FIG. 4, illustrates, in one embodiment, the different steps followed by the computation manager to generate adaptive management strategies. Computation manager 410 can comprise the components discussed and can reside in the edge domain, such as described in FIG. 1.

Step 0: The user/cloud analyst 440 (e.g., a person or system managing the edge domain) provides a description of the MDP specification or model 450 to computation manager 410 including, for example, one or more of the following items: number of states, states, possible actions, reward values, possible transitions.

Step 1: Using the “Computation Constraints Descriptor” 420, the computation manager 410 gets the description of constraints or requirements from the edge domain 425 that should be considered while managing the received requests including, for example: overall utilization of resources, workload load rate, energy consumption rate, etc. This step can comprise the process in which, e.g., a computation manager 170 of FIGS. 1-3 queries or receives from the computation analyzer appropriate criteria by which to strategize a response to a computation management request, and/or application/user specification information. For example, energy consumption in some embodiments may be a chosen criterion/a by which to assess a response to a computation management request. The importance of energy consumption may impact how various factors are weighed in further steps, for example, which of several network or remote resources to use in responding to a computation management request. Different resources may have different levels of energy efficiency. In another example, speed may be considered more important than efficiency, and different resources may have different speeds, latency, or other characteristics, statically or dynamically.

Step 2: Using the “Cloud Events Descriptor” 430, the computation manager 410 gets the description of events experienced by the edge domain 425 to capture the different variations that could characterize the network, energy use, availability of resources, failures rate, workload variation, etc. This step can comprise the process by which, e.g., a computation manager 170 of FIGS. 1-3 queries or receives static and dynamic status information from a discovery engine 180.

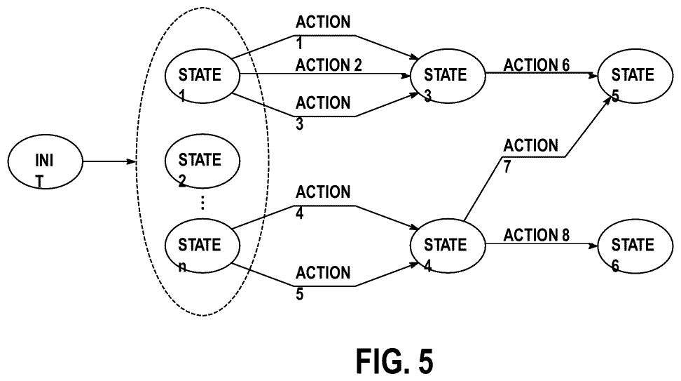

Step 3: The “MDP Mapper” 460 maps the input MDP model 450 to the data collected from the edge domain 425 (description of the constraints and events in the cloud-edge), to discover the states and transitions to be used to train specific RL methods (Q-learning and SARSA) as described herein. An example of the states and transitions can be seen in FIG. 5. FIG. 5 shows an example of an MDP model 450. As shown, the MDP model 450 can comprise various states and actions for proceeding from one state to another. At this point in the process shown in FIG. 4, the preferred actions (Action 1, Action 2, etc.) for reaching state3, or state5 or state6, has not been determined. But the MDP model 450 can help in laying out what states are desired and possible courses of action for attaining those states. If an identified criterion, such as energy use, has been identified as important for a given computation management request, then that criterion may be used in assessing preferred actions and states. For example, several different actions may lead to the same state, but consume more or less energy. If energy efficiency is a preferred criterion, then lower energy actions may be preferred. Identifying an appropriate criterion by which to refine a response to a computation management request will often impact how different resources are judged, or how application/user specifications are assessed.

Step 4 and Step 5: The “RL Model Engine” 470 uses the input MDP data (Step 4) and offline data about computation management requests (Step 5) to train Q-Learning 474 and SARSA algorithms 476 to get a Q-DataBase (Q-DB) 480. The Q-DB 480 stores the Q-table values obtained while training the RL models. An example of an RL Q-Table is presented in Table 2. Table 2 can show values calculated as described in relation to Table 1. The probability or success rate for each action, at the respective state, are shown. Steps 4 and 5 can comprise the process in which, e.g., computation manager 170 develops management strategies or accesses historical management strategies and their success rates.

TABLE 2
Example of RL Q-Table

| | Action | Action | Action | Action | Action | Action |
|---|---|---|---|---|---|---|
| | 1 | 2 | 3 | 4 | 5 | . . . |
| State 1 | 0.4 | | | | | |
| State 2 | | 0.3 | | | | |
| State 3 | | | | | 1 | |
| State 4 | | | | | 0.2 | 1 |
| State 5 | | | | 0 | | |
| State 6 | | | | | | −0.5 |
| State n | | | | | 1 | |

Step 6: The computation manager 410 maps the data about the received computation management request to the MDP model 450 to identify its corresponding state (current state) and hence to identify the possible actions to be applied and the corresponding rewards according to the MDP description. The generated output here will be a list of possible strategies to be applied based on the criteria obtained by the computation analyzer: [current state, {<action 1, next state 1, reward 1, Q-value1>, <action 2, next state 2, reward 2, Q-value 2>, . . . , <action n, next state n, reward n, Q-value n>}]. Step 6 can comprise the process in which, e.g., the computation manager 170 assesses and/or compares how the various management strategies it is considering will perform, often according to the identified criteria (lowest energy use, quickest, and/or other criteria).

Step 7: The strategy selector 490 analyzes the list of obtained strategies and their corresponding updates to the strategy that satisfies the criteria selected by the computation analyzer and the application and user specifications. It first checks previously used computation management strategies in the computation management strategies database 495 to find similar ones and check their success rates when applied by the computation agent. It identifies the candidate strategies that satisfies mostly the request criteria and meet the identified cloud constraints and events. Examples of management strategies could be: <execute task T1 from application A1 on edge node 1, offload tasks T2 and T3 on edge node 3 and execute task T4 locally, execute task T5 locally, etc.>. The proposed architecture can be implemented and deployed within any distributed or centralized cloud and edge domains. In addition, it can be implemented in one module as it can be distributed in different modules that are connected. Step 7 can comprise the process by which, e.g., computation manager 170 generates a chosen management strategy from amongst the possible strategies it has considered.

Embodiments under the present disclosure can be deployed in different edge and cloud environments and could be adapted to different IoT devices or other devices. This is because it does not depend on a specific type of cloud or edge where it could be deployed or specific type of devices to start the computation management request. It can focus on types of computations to be processed in the edge cloud and how to select the appropriate strategy to ensure its successful processing and to guarantee the SLA requirements. In addition, embodiments include self-learning architecture that adapts its decisions according to the changes captured from the monitored edge-cloud system.

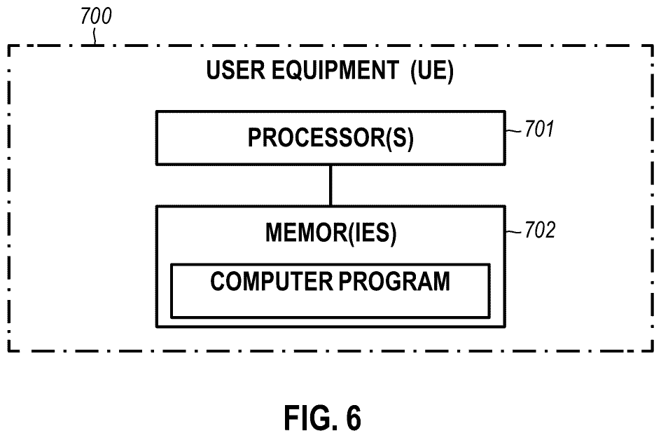

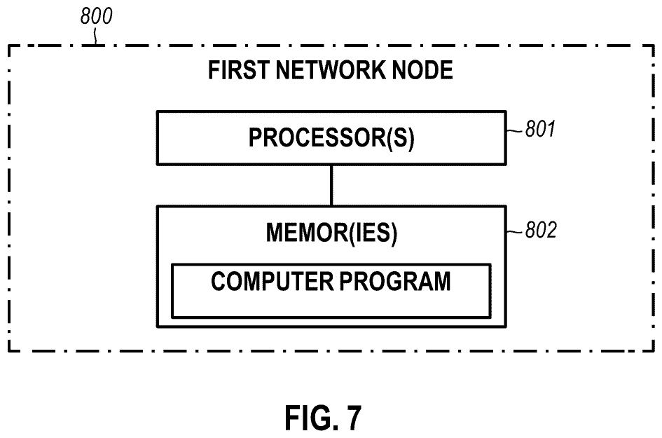

FIGS. 6-7 show schematic block diagrams of a UE 700 and a network node 800 according to embodiments of the present disclosure. The UE 700 may include at least a processor 701 and at least a memory 702. As shown in FIG. 6, the memory 702 has stored thereon a computer program which, when executed on the processor 701, causes the processor 701 to carry out any of the methods performed in the UE 700 according to the present disclosure. As shown in FIG. 7, the memory 802 has stored thereon a computer program which, when executed on the processor 801, causes the processor 801 to carry out any of the methods performed in the computation management system according to the present disclosure. The memory 702/802 may be, e.g., an Electrically Erasable Programmable Read-Only Memory (EEPROM), a flash memory and a hard drive. The processor may be a single CPU (Central processing unit), but could also comprise two or more processing units. For example, the processor may include general purpose microprocessors; instruction set processors and/or related chips sets and/or special purpose microprocessors such as Application Specific Integrated Circuit (ASICs). The processor may also comprise board memory for caching purposes. The computer program may be carried by a computer program product connected to the processor. The computer program product may comprise a computer readable medium on which the computer program is stored. For example, the computer program product may be a flash memory, a Random-access memory (RAM), a Read-Only Memory (ROM), or an EEPROM, and the computer program modules could in alternative embodiments be distributed on different computer program products in the form of memories within the UE or the network nodes.

In an embodiment of the present disclosure, there is provided a computer-readable storage medium having stored thereon a computer program which, when executed on at least one processor, causes the at least one processor to carry out any applicable method according to the present disclosure. Embodiments under the present disclosure can include systems and methods wherein a UE, such as described above, comprises a node in a mesh network.

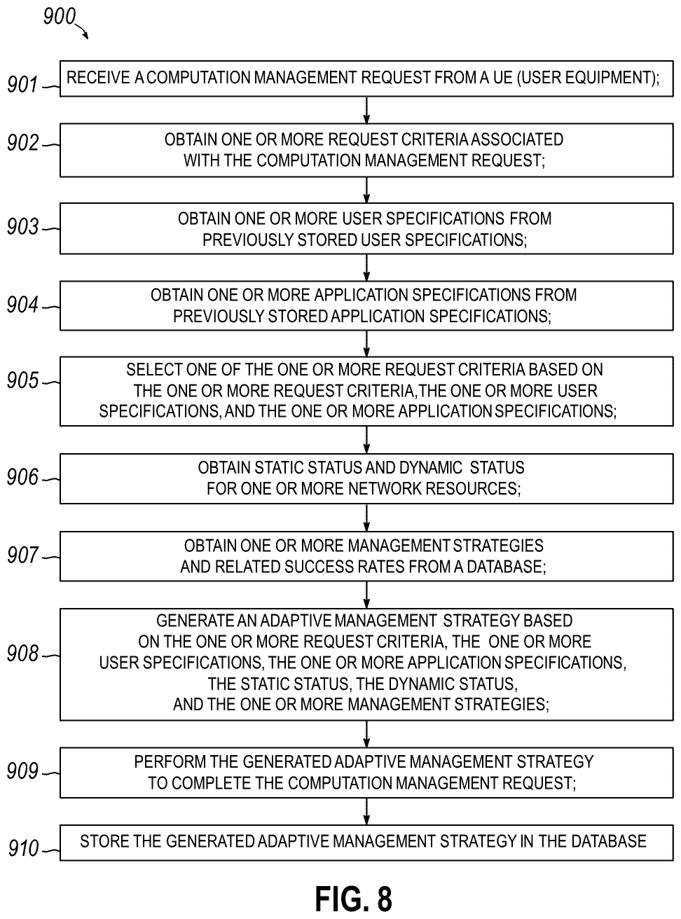

FIGS. 8-10 display possible method embodiments under the present disclosure.

FIG. 8 shows a method 900 performed by a computation management system for performing edge cloud computation management. The steps can include, 901, to receive a computation management request from a UE (user equipment). Step 902 is to obtain one or more request criteria associated with the computation management request. Step 903 is to obtain one or more user specifications from previously stored user specifications. Step 904 is to obtain one or more application specifications from previously stored application specifications. Step 905 is to select one of the one or more request criteria based on the one or more request criteria, the one or more user specifications, and the one or more application specifications. Step 906 is to obtain static status and dynamic status for one or more network resources. Step 907 is to obtain one or more management strategies and related success rates from a database. Step 908 is to generate an adaptive management strategy based on the one or more request criteria, the one or more user specifications, the one or more application specifications, the static status, the dynamic status, and the one or more management strategies. Step 909 is to perform the generated adaptive management strategy to complete the computation management request. Step 910 is to store the generated adaptive management strategy in the database.

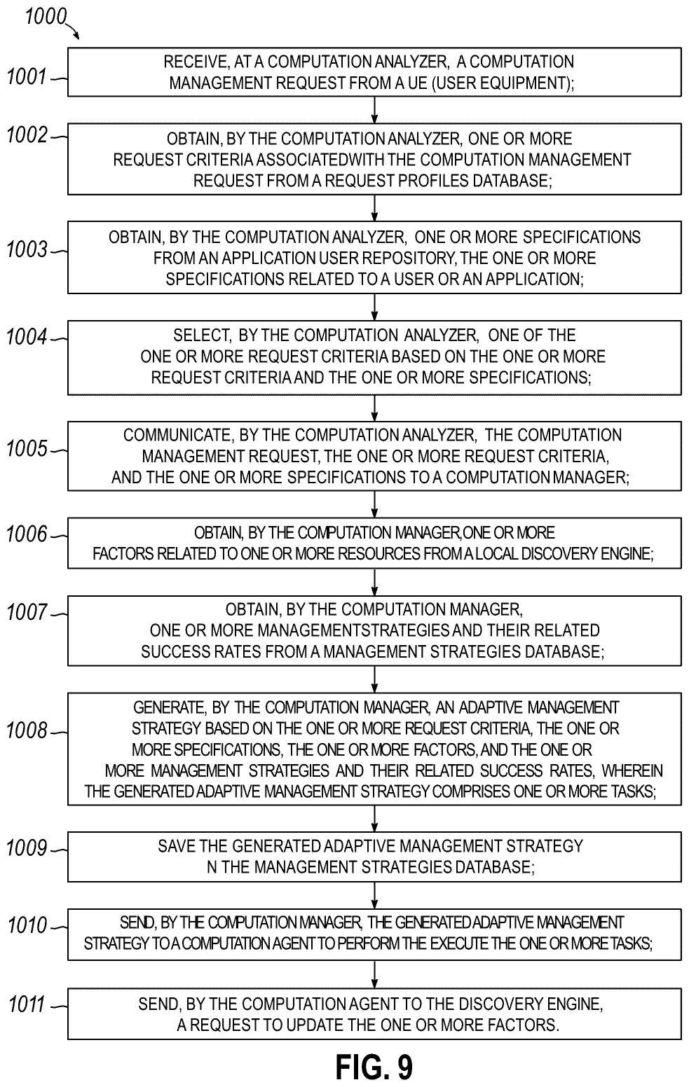

FIG. 9 displays a method 1000 performed by a computation management system for performing edge cloud computation management. Step 1001 is to receive, at a computation analyzer, a computation management request from a UE (user equipment). Step 1002 is to obtain, by the computation analyzer, one or more request criteria associated with the computation management request from a request profiles database. Step 1003 is to obtain, by the computation analyzer, one or more specifications from a specification repository, the one or more specifications related to a user and/or an application. Step 1004 is to select, by the computation analyzer, one of the one or more request criteria based on the one or more request criteria and the one or more specifications. Step 1005 is to communicate, by the computation analyzer, the computation management request, the one or more request criteria, and the one or more specifications to a computation manager. Step 1006 is to obtain, by the computation manager, one or more factors related to one or more resources from a local discovery engine. Step 1007 is to obtain, by the computation manager, one or more management strategies and their related success rates from a management strategies database. Step 1008 is to generate, by the computation manager, an adaptive management strategy based on the one or more request criteria, the one or more specifications, the one or more factors, and the one or more management strategies and their related success rates, wherein the generated adaptive management strategy comprises one or more tasks. Step 1009 is to save the generated adaptive management strategy in the management strategies database. Step 1010 is to send, by the computation manager, the generated adaptive management strategy to a computation agent to perform the execute the one or more tasks. And step 1011 is to send, by the computation agent to the discovery engine, a request to update the one or more factors.

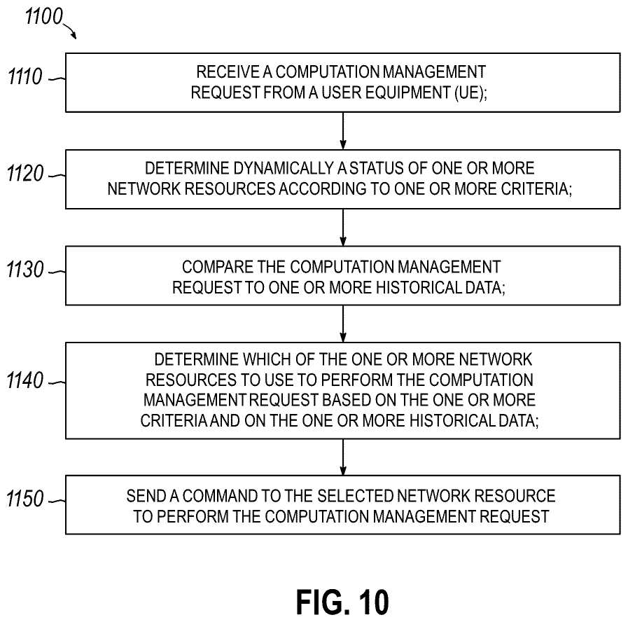

FIG. 10 displays a method 1100 performed by a network node for performing edge cloud computation management. Step 1110 is to receive a computation management request from a user equipment (UE). Step 1120 is to determine dynamically a status of one or more network resources according to one or more criteria. Step 1130 is to compare the computation management request to one or more historical data. Step 1140 is to determine which of the one or more network resources to use to perform the computation management request based on the one or more criteria and the one or more historical data. Step 1150 is to send a command to the selected network resource to perform the computation management request.

### Computer Systems of the Present Disclosure

It will be appreciated that computer systems are increasingly taking a wide variety of forms. In this description and in the claims, the terms “controller,” “computer system,” or “computing system” are defined broadly as including any device or system—or combination thereof—that includes at least one physical and tangible processor and a physical and tangible memory capable of having thereon computer-executable instructions that may be executed by a processor. By way of example, not limitation, the term “computer system” or “computing system,” as used herein is intended to include personal computers, desktop computers, laptop computers, tablets, hand-held devices (e.g., mobile telephones, PDAs, pagers), microprocessor-based or programmable consumer electronics, minicomputers, mainframe computers, multi-processor systems, network PCs, distributed computing systems, datacenters, message processors, routers, switches, and even devices that conventionally have not been considered a computing system, such as wearables (e.g., glasses).

The memory may take any form and may depend on the nature and form of the computing system. The memory can be physical system memory, which includes volatile memory, non-volatile memory, or some combination of the two. The term “memory” may also be used herein to refer to non-volatile mass storage such as physical storage media.

The computing system also has thereon multiple structures often referred to as an “executable component.” For instance, the memory of a computing system can include an executable component. The term “executable component” is the name for a structure that is well understood to one of ordinary skill in the art in the field of computing as being a structure that can be software, hardware, or a combination thereof.

For instance, when implemented in software, one of ordinary skill in the art would understand that the structure of an executable component may include software objects, routines, methods, and so forth, that may be executed by one or more processors on the computing system, whether such an executable component exists in the heap of a computing system, or whether the executable component exists on computer-readable storage media. The structure of the executable component exists on a computer-readable medium in such a form that it is operable, when executed by one or more processors of the computing system, to cause the computing system to perform one or more functions, such as the functions and methods described herein. Such a structure may be computer-readable directly by a processor—as is the case if the executable component were binary. Alternatively, the structure may be structured to be interpretable and/or compiled—whether in a single stage or in multiple stages—so as to generate such binary that is directly interpretable by a processor.

The term “executable component” is also well understood by one of ordinary skill as including structures that are implemented exclusively or near-exclusively in hardware logic components, such as within a field programmable gate array (FPGA), an application specific integrated circuit (ASIC), Program-specific Standard Products (ASSPs), System-on-a-chip systems (SOCs), Complex Programmable Logic Devices (CPLDs), or any other specialized circuit. Accordingly, the term “executable component” is a term for a structure that is well understood by those of ordinary skill in the art of computing, whether implemented in software, hardware, or a combination thereof.

The terms “component,” “service,” “engine,” “module,” “control,” “generator,” or the like may also be used in this description. As used in this description and in this case, these terms—whether expressed with or without a modifying clause—are also intended to be synonymous with the term “executable component” and thus also have a structure that is well understood by those of ordinary skill in the art of computing.

While not all computing systems require a user interface, in some embodiments a computing system includes a user interface for use in communicating information from/to a user. The user interface may include output mechanisms as well as input mechanisms. The principles described herein are not limited to the precise output mechanisms or input mechanisms as such will depend on the nature of the device. However, output mechanisms might include, for instance, speakers, displays, tactile output, projections, holograms, and so forth. Examples of input mechanisms might include, for instance, microphones, touchscreens, projections, holograms, cameras, keyboards, stylus, mouse, or other pointer input, sensors of any type, and so forth.

Accordingly, embodiments described herein may comprise or utilize a special purpose or general-purpose computing system. Embodiments described herein also include physical and other computer-readable media for carrying or storing computer-executable instructions and/or data structures. Such computer-readable media can be any available media that can be accessed by a general purpose or special purpose computing system. Computer-readable media that store computer-executable instructions are physical storage media. Computer-readable media that carry computer-executable instructions are transmission media. Thus, by way of example—not limitation—embodiments disclosed or envisioned herein can comprise at least two distinctly different kinds of computer-readable media: storage media and transmission media.

Computer-readable storage media include RAM, ROM, EEPROM, solid state drives (“SSDs”), flash memory, phase-change memory (“PCM”), CD-ROM or other optical disk storage, magnetic disk storage or other magnetic storage devices, or any other physical and tangible storage medium that can be used to store desired program code in the form of computer-executable instructions or data structures and that can be accessed and executed by a general purpose or special purpose computing system to implement the disclosed functionality or functionalities. For example, computer-executable instructions may be embodied on one or more computer-readable storage media to form a computer program product.

Transmission media can include a network and/or data links that can be used to carry desired program code in the form of computer-executable instructions or data structures and that can be accessed and executed by a general purpose or special purpose computing system. Combinations of the above should also be included within the scope of computer-readable media.

Further, upon reaching various computing system components, program code in the form of computer-executable instructions or data structures can be transferred automatically from transmission media to storage media (or vice versa). For example, computer-executable instructions or data structures received over a network or data link can be buffered in RAM within a network interface module (e.g., a “NIC”) and then eventually transferred to computing system RAM and/or to less volatile storage media at a computing system. Thus, it should be understood that storage media can be included in computing system components that also—or even primarily—utilize transmission media.

Those skilled in the art will further appreciate that a computing system may also contain communication channels that allow the computing system to communicate with other computing systems over, for example, a network. Accordingly, the methods described herein may be practiced in network computing environments with many types of computing systems and computing system configurations. The disclosed methods may also be practiced in distributed system environments where local and/or remote computing systems, which are linked through a network (either by wired data links, wireless data links, or by a combination of wired and wireless data links), both perform tasks. In a distributed system environment, the processing, memory, and/or storage capability may be distributed as well.

Those skilled in the art will also appreciate that the disclosed methods may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud-computing model can be composed of various characteristics, such as on-demand self-service, broad network access, resource pooling, rapid elasticity, measured service, and so forth. A cloud-computing model may also come in the form of various service models such as, for example, Software as a Service (“SaaS”), Platform as a Service (“PaaS”), and Infrastructure as a Service (“IaaS”). The cloud-computing model may also be deployed using different deployment models such as private cloud, community cloud, public cloud, hybrid cloud, and so forth.

### Abbreviations and Defined Terms

To assist in understanding the scope and content of this written description and the appended claims, a select few terms are defined directly below. Unless defined otherwise, all technical and scientific terms used herein have the same meaning as commonly understood by one of ordinary skill in the art to which the present disclosure pertains.

The terms “approximately,” “about,” and “substantially,” as used herein, represent an amount or condition close to the specific stated amount or condition that still performs a desired function or achieves a desired result. For example, the terms “approximately,” “about,” and “substantially” may refer to an amount or condition that deviates by less than 10%, or by less than 5%, or by less than 1%, or by less than 0.1%, or by less than 0.01% from a specifically stated amount or condition.

Various aspects of the present disclosure, including devices, systems, and methods may be illustrated with reference to one or more embodiments or implementations, which are exemplary in nature. As used herein, the term “exemplary” means “serving as an example, instance, or illustration,” and should not necessarily be construed as preferred or advantageous over other embodiments disclosed herein. In addition, reference to an “implementation” of the present disclosure or embodiments includes a specific reference to one or more embodiments thereof, and vice versa, and is intended to provide illustrative examples without limiting the scope of the present disclosure, which is indicated by the appended claims rather than by the present description.

As used in the specification, a word appearing in the singular encompasses its plural counterpart, and a word appearing in the plural encompasses its singular counterpart, unless implicitly or explicitly understood or stated otherwise. Thus, it will be noted that, as used in this specification and the appended claims, the singular forms “a,” “an” and “the” include plural referents unless the context clearly dictates otherwise. For example, reference to a singular referent (e.g., “a widget”) includes one, two, or more referents unless implicitly or explicitly understood or stated otherwise. Similarly, reference to a plurality of referents should be interpreted as comprising a single referent and/or a plurality of referents unless the content and/or context clearly dictate otherwise. For example, reference to referents in the plural form (e.g., “widgets”) does not necessarily require a plurality of such referents. Instead, it will be appreciated that independent of the inferred number of referents, one or more referents are contemplated herein unless stated otherwise.

As used herein, directional terms, such as “top,” “bottom,” “left,” “right,” “up,” “down,” “upper,” “lower,” “proximal,” “distal,” “adjacent,” and the like are used herein solely to indicate relative directions and are not otherwise intended to limit the scope of the disclosure and/or claimed embodiments.

The following abbreviations are used in the present disclosure:
IoT Internet of Things
RAT Radio Access Technologies
UE User Equipment
Virtual Machine
QOS Quality of Service
CA Computation Analyzer
PSO Particle Swarm Optimization
CM Computation Manager
RL Reinforcement Learning
MDP Markov Decision Process
SARSA State-Action-Reward-State-Action

### Conclusion

It is understood that for any given component or embodiment described herein, any of the possible candidates or alternatives listed for that component may generally be used individually or in combination with one another, unless implicitly or explicitly understood or stated otherwise. Additionally, it will be understood that any list of such candidates or alternatives is merely illustrative, not limiting, unless implicitly or explicitly understood or stated otherwise.

In addition, unless otherwise indicated, numbers expressing quantities, constituents, distances, or other measurements used in the specification and claims are to be understood as being modified by the term “about,” as that term is defined herein. Accordingly, unless indicated to the contrary, the numerical parameters set forth in the specification and attached claims are approximations that may vary depending upon the desired properties sought to be obtained by the subject matter presented herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the subject matter presented herein are approximations, the numerical values set forth in the specific examples are reported as precisely as possible. Any numerical values, however, inherently contain certain errors necessarily resulting from the standard deviation found in their respective testing measurements.

Any headings and subheadings used herein are for organizational purposes only and are not meant to be used to limit the scope of the description or the claims.

The terms and expressions which have been employed herein are used as terms of description and not of limitation, and there is no intention in the use of such terms and expressions of excluding any equivalents of the features shown and described or portions thereof, but it is recognized that various modifications are possible within the scope of the present disclosure. Thus, it should be understood that although the present disclosure has been specifically disclosed in part by preferred embodiments, exemplary embodiments, and optional features, modification and variation of the concepts herein disclosed may be resorted to by those skilled in the art, and such modifications and variations are considered to be within the scope of this present description.

It will also be appreciated that systems, devices, products, kits, methods, and/or processes, according to certain embodiments of the present disclosure may include, incorporate, or otherwise comprise properties or features (e.g., components, members, elements, parts, and/or portions) described in other embodiments disclosed and/or described herein. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

All references cited in this application are hereby incorporated in their entireties by reference to the extent that they are not inconsistent with the disclosure in this application. It will be apparent to one of ordinary skill in the art that methods, devices, device elements, materials, procedures, and techniques other than those specifically described herein can be applied to the practice of the described embodiments as broadly disclosed herein without resort to undue experimentation. All art-known functional equivalents of methods, devices, device elements, materials, procedures, and techniques specifically described herein are intended to be encompassed by this present disclosure.

When a group of materials, compositions, components, or compounds is disclosed herein, it is understood that all individual members of those groups and all subgroups thereof are disclosed separately. When a Markush group or other grouping is used herein, all individual members of the group and all combinations and sub-combinations possible of the group are intended to be individually included in the disclosure.

The above-described embodiments are examples only. Alterations, modifications and variations may be effected to the particular embodiments by those of skill in the art without departing from the scope of the description, which is defined solely by the appended claims.

1. A method performed by a computation management system for performing edge cloud computation management, the method comprising:
receiving (901) a computation management request from a UE (user equipment);
obtaining (902) one or more request criteria associated with the computation management request;
obtaining (903) one or more user specifications from previously stored user specifications;
obtaining (904) one or more application specifications from previously stored application specifications;
selecting (905) one of the one or more request criteria based on the one or more request criteria, the one or more user specifications, and the one or more application specifications;
obtaining (906) static status and dynamic status for one or more edge cloud resources;
obtaining (907) one or more management strategies and related success rates from a database;
generating (908) an adaptive management strategy based on the one or more request criteria, the one or more user specifications, the one or more application specifications, the static status of the one or more edge cloud resources, the dynamic status of the one or more edge cloud resources, and the one or more management strategies; and
performing (909) the generated adaptive management strategy to complete the computation management request.

2. The method of claim 1 wherein the UE (700) comprises one of: mobile device, smart car, smart watch, Virtual Reality (VR) glass.

3. The method of claim 1, wherein the computation management request comprises at least one of: application, service, user, time, location, battery level, program code, application specification, user requirement.

4. The method of claim 1, wherein the one or more request criteria comprises at least one of: latency, cost, total resource utilization.

5. The method of claim 1, wherein the static status or dynamic status of the one or more edge cloud resources comprises at least one of:
availability, utilization rate, maximum allowed capacity, node location, running load, failure rate, energy consumption level.

6. The method of claim 1, wherein the one or more edge cloud resources comprise local resources, remote resources, or both local and remote resources.

7. The method of claim 1, further comprising assessing a result of the generated adaptive management strategy and storing the result in the database.

8. The method of claim 1, further comprising sending a result of the generated adaptive management strategy to the UE.

9. The method of claim 1, wherein the one or more user specifications or the one or more application specifications comprises at least one of:
application, service, user, time, location, battery level, program code, application specification, user requirement.

10. The method of claim 1, further comprising updating the static and/or dynamic status for the one or more edge cloud resources.

11. The method of claim 1, wherein success rate for the one or more management strategies is calculated based on at least one of: historical success rate, current defined importance of criteria, and the one or more specifications

12. The method of claim 1, wherein the generating an adaptive management strategy comprises using Reinforcement Learning (RL).

13. The method of claim 12 wherein the generating an adaptive management strategy comprises using a Markov Decision Process (MDP).

14. The method of claim 12 wherein the Reinforcement Learning comprises at least one of: Q-learning and SARSA (State Action Reward State Action).

15. The method of claim 12, wherein the Reinforcement Learning comprises a RL model engine configured to train a learning algorithm to obtain a Q-Database.

16. A method performed by a network node for performing edge cloud computation management, the method comprising:
receiving (1110) a computation management request from a user equipment (UE);
dynamically determining (1120) a status of one or more edge cloud resources according to one or more criteria;
comparing (1130) the computation management request to one or more historical data;
determining (1140) which of the one or more edge cloud resources to use to perform the computation management request based on the one or more criteria and the one or more historical data; and
sending (1150) a command to the selected edge cloud resource to perform the computation management request.

17. An edge cloud resource management system (100) comprising:
a computation analyzer (160) configured to; receive computation management requests from a UE (user equipment); obtain one or more request criteria associated with the computation management request from a request profiles database (150); obtain one or more specifications related to a user or an application from an specifications repository (155); select one or more of the request criteria based on the one or more request criteria and the one or more specifications;
a discovery engine (180) configured to store one or more factors related to one or more resources;
a computation manager (170) configured to; receive the computation management request, the one or more request criteria and the one or more specifications from the computation analyzer; receive the one or more factors from the discovery engine; obtain one or more management strategies and related success rates from a management strategies database (165); generate an adaptive management strategy comprising one or more tasks and based on the one or more request criteria, the one or more specifications, the one or more factors, and the one or more management strategies and their related success rates; and
a computation agent (175) configured to; receive the generated adaptive management strategy from the computation manager and to manage the performance of the one or more tasks.

18.-20. (canceled)

21. The system of claim 17 wherein a network node comprises the computation analyzer and the computation manager, discovery engine, and computation agent comprise one or more other network components.

22. A first network node (800), comprising,
a processor (801); and
a memory (802) having stored thereon a computer program which, when executed on the processor, causes the processor to carry out the method according to claim 1.

23. A non-transitory computer-readable storage medium, having stored thereon a computer program which, when executed on at least one processor, causes the at least one processor to carry out the method according to claim 1.
